(19) United States
(12) Patent Application Publication
(10) Pub. No.: US 2014/0095287 A1
(43) Pub. Date: Apr. 3, 2014

(54) SYSTEM AND METHOD FOR AUTOMATIC AND IDENTIFIABLE COUPON REDEMPTION

(71) Applicant: MASTERCARD INTERNATIONAL INCORPORATED, Purchase, NY (US)

(72) Inventor: Stephen WHITNEY, Monkstown (IE)

(73) Assignee: MasterCard International Incorporated, Purchase, NY (US)

(21) Appl. No.: 13/633,384

(22) Filed: Oct. 2, 2012

(51) Int. Cl. G06Q 30/02

(52) U.S. Cl. 705/14.26

(57) ABSTRACT

A method for distributing coupons includes: storing consumer profiles, each profile including a consumer identifier and authentication information; storing coupons, each coupon including a coupon identifier, consumer identification, reward, and merchant identifier; receiving a request, the request including authentication data and merchant information; identifying a consumer profile for a consumer based on the authentication information and the authentication data; identifying a coupon associated with the merchant information and the consumer profile; and transmitting, to a merchant, the coupon. A method for applying coupons includes: receiving a coupon, the coupon including an identifier, reward, and a merchant or product identifier; transmitting the coupon to a consumer where the coupon includes the merchant identifier or the product identifier corresponds to the product; receiving instruction to apply the coupon; modifying a transaction amount based on the associated reward; and submitting an authorization request for the transaction based on the modified amount.

### FIELD

The present disclosure relates to automatic and identifiable coupon redemption, specifically the automatic identification of coupons for use in an e-commerce transaction prior to authorization.

### BACKGROUND

In recent times, coupons, deals, offers, and other discounts have become a large part of marketing efforts by merchants and manufacturers. Offering consumers a deal can result in an increase in revenue, and a repeat customer that could result in even greater gains over a period of time. Deals also provide an avenue of exposure of a merchant or manufacturer to consumers that may not have been aware of the merchant or manufacturer prior to the deal, or may convince an apprehensive consumer to transact with the entity when they otherwise may not have.

Traditionally, coupons and other deals often came in the form of paper coupons often with machine-readable codes included in newspapers and magazines. To redeem such a coupon, a consumer would have to obtain a copy of the newspaper or magazine, locate the coupon, remove or “clip” the coupon, take it to the merchant, and then present it to the merchant as part of the checkout process. As the Internet became used more and more for transactions, the use of coupons in Internet and other e-commerce transactions also increased.

Some merchant websites may display coupons or deals that may be interacted with (e.g., clicked on) by the consumer in order to attach them to a transaction. However, these coupons or deals are often merchant specific, and may not be tailored to the specific consumer. An additional and more widely used method for using a coupon in an e-commerce transaction may involve entering a code associated with the coupon into a field as part of the checkout process for the transaction. The use of coupon codes again may not be tailored to a specific consumer. Using coupon codes may also be a cumbersome process as a consumer would have to find the coupon, identify the code, and then remember to use the code when eventually engaging in the transaction.

Thus, there is a need for a technical solution to receiving and applying coupons for use in an e-commerce transaction that does not require the entry of codes and can be tailored to a specific consumer.

### SUMMARY

The present disclosure provides a description of a system and method for distributing coupons for use in a financial transaction and a system and method for receiving and applying coupons for use in a financial transaction.

A method for distributing coupons for use in a financial transaction includes: storing, in a consumer database, a plurality of consumer data entries, wherein each consumer data entry is associated with a consumer and includes at least a consumer identifier and authentication information; storing, in a coupon database, a plurality of coupons, wherein each coupon includes at least a coupon identifier, a consumer identification, a reward, and a merchant and/or product identifier; receiving, by a receiving device, a coupon request, wherein the coupon request includes at least authentication data and merchant information; identifying, by a processing device, a consumer data entry in the consumer database associated with a consumer based on the associated authentication information and the received authentication data; identifying, by the processing device, at least one redeemable coupon in the coupon database based on a comparison of the associated merchant and/or product identifier and the received merchant information and wherein the consumer identification of each coupon of the at least one redeemable coupon corresponds to the consumer identifier of the identified consumer data entry; and transmitting, to a merchant corresponding to the merchant information, the at least one redeemable coupon for presentation to the consumer.

A method for receiving and applying coupons for use in a financial transaction includes: storing, in a database, transaction information for a financial transaction to be processed, wherein the transaction information includes at least a transaction amount and at least one product to be purchased; receiving, by a receiving device, at least one redeemable coupon from a third party, wherein each of the at least one redeemable coupon includes at least a coupon identifier, a reward, and at least one of a merchant identifier and a product identifier; transmitting, by a transmitting device, each redeemable coupon of the at least one redeemable coupon to a consumer where (i) the redeemable coupon includes the merchant identifier or (ii) the associated product identifier corresponds to one of the at least one product to be purchased; receiving, from the consumer, an indication of a coupon to be applied to the financial transaction; modifying, in the database, the transaction information for the financial transaction to be processed based on the reward associated with the indicated coupon; and submitting an authorization request for the financial transaction based on the modified transaction information.

A system for distributing coupons for use in a financial transaction includes a consumer database, a coupon database, a receiving device, a processing device, and a transmitting device. The consumer database is configured to store a plurality of consumer data entries, wherein each consumer data entry is associated with a consumer and includes at least a consumer identifier and authentication information. The coupon database is configured to store a plurality of coupons, wherein each coupon includes at least a coupon identifier, a consumer identification, a reward, and a merchant and/or product identifier. The receiving device is configured to receive a coupon request, wherein the coupon request includes at least authentication data and merchant information. The processing device is configured to: identify a consumer data entry in the consumer database associated with a consumer based on the associated authentication information and the received authentication data; and identify at least one redeemable coupon in the coupon database based on a comparison of the associated merchant and/or product identifier and the received merchant information and wherein the consumer identification of each coupon of the at least one redeemable coupon corresponds to the consumer identifier of the identified consumer data entry. The transmitting device is configured to transmit, to a merchant corresponding to the merchant information, the at least one redeemable coupon for presentation to the consumer.

A system for receiving coupons and applying coupons for use in a financial transaction includes a database, a receiving device, a transmitting device, and a processing device. The database is configured to store transaction information for a financial transaction to be processed, wherein the transaction information includes at least a transaction amount and at least one product to be purchased. The receiving device is configured to receive at least one redeemable coupon from a third party, wherein each of the at least one redeemable coupon includes at least a coupon identifier, a reward, and at least one of a merchant identifier and a product identifier. The transmitting device is configured to transmit each redeemable coupon of the at least one redeemable coupon to a consumer where (i) the redeemable coupon includes the merchant identifier or (ii) the associated product identifier corresponds to one of the at least one product to be purchased. The processor is configured to: cause the receiving device to receive, from the consumer, an indication of a coupon to be applied to the financial transaction; modify, in the database, the transaction information for the financial transaction to be processed based on the reward associated with the indicated coupon; and submit an authorization request for the financial transaction based on the modified transaction information.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for distributing, receiving, and applying coupons in a financial transaction in accordance with exemplary embodiments.

FIG. 2 is a block diagram illustrating a processing server for use in the system of FIG. 1 in accordance with exemplary embodiments.

FIG. 3 is a block diagram illustrating a merchant server for use in the system of FIG. 1 in accordance with exemplary embodiments.

FIG. 4 is a block diagram illustrating a coupon database of the processing server of FIG. 2 in accordance with exemplary embodiments.

FIGS. 5A-5D are diagrams illustrating a graphical user interface for receiving and applying coupons to a financial transaction using the system of FIG. 1 in accordance with exemplary embodiments.

FIGS. 6A and 6B are a processing flow illustrating a method for the distribution and application of coupons in a financial transaction in accordance with exemplary embodiments.

FIG. 7 is a block diagram illustrating system architecture of a computer system in accordance with exemplary embodiments.

FIG. 8 is a flow chart illustrating an exemplary method for distributing coupons for use in a financial transaction in accordance with exemplary embodiments.

FIG. 9 is a flow chart illustrating an exemplary method for receiving and applying coupons for use in a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Distributing and Processing Coupons for a Financial Transaction

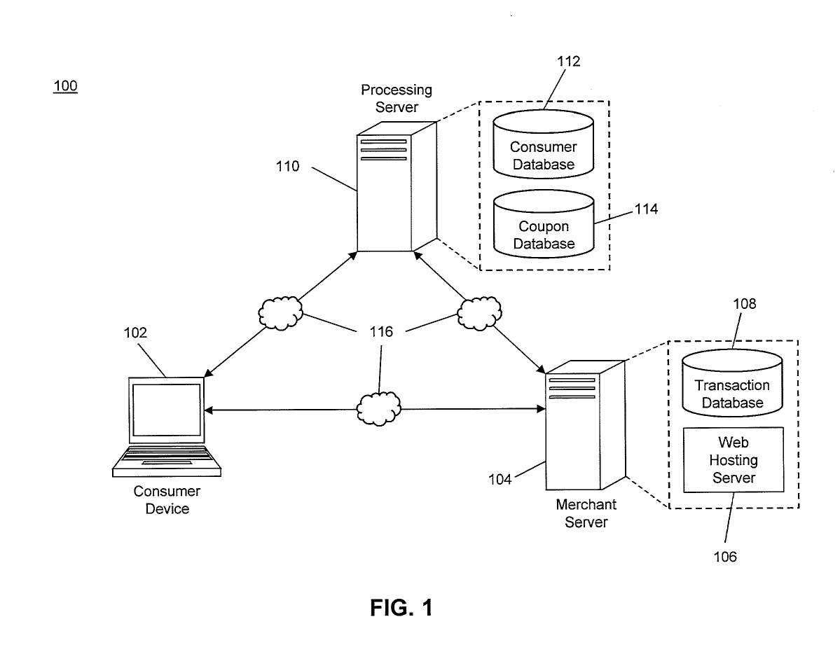

FIG. 1 illustrates a system 100 for processing a reservation and approving and processing a financial transaction. The system 100 may include a consumer device 102, a merchant server 104, and a processing server 110. Each of the components may be configured to communicate via a network 116. The network 116 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

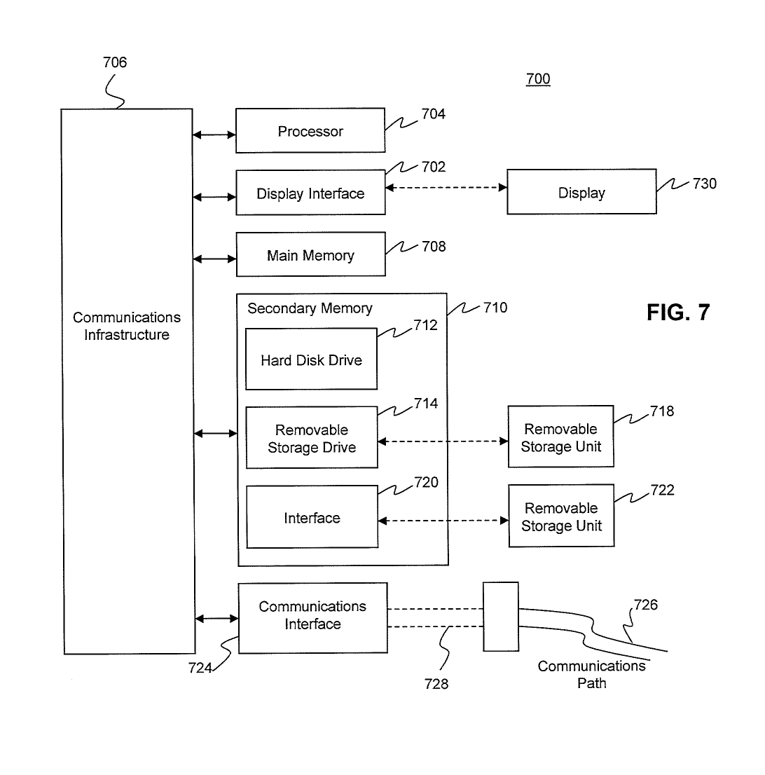

The consumer device 102 may be any device suitable for performing the functions as disclosed herein, such as the computer system illustrated in FIG. 7, discussed in more detail below. For example, the consumer device 102 may be a desktop computer, laptop computer, notebook computer, tablet computer, smart phone, etc. A user (e.g., a consumer) of the consumer device 102 may engage in a financial transaction with the merchant server 104 over the network 116, such as via a website operated by or on behalf of a merchant. In some embodiments, the merchant server 106 may include a web hosting server 106, which may host a website through which the consumer device 102 may engage in a financial transaction. Suitable types and configurations of the web hosting server 106 and the merchant server 104 will be apparent to persons having skill in the relevant art.

The merchant server 104 may include a transaction database 108, which may store details regarding the financial transaction between the merchant server 104 and the consumer device 102. Transaction details stored in the transaction database 108 may include product information (e.g., product names, product prices, product categories, product identifiers, etc.), funding details, a transaction amount, and any other information suitable for performing the functions as disclosed herein as will be apparent to persons having skill in the relevant art.

Separate from or as part of the financial transaction with the merchant server 104, the consumer of the consumer device 102 may enroll with a discount service offered by the processing server 110. Enrollment in the discount service may include the consumer providing (e.g., via the consumer device 102) authentication or identification information to the processing server 110 for establishing an account, such as name, phone number, e-mail address, mailing address, username, password, or any other suitable information. The processing server 110 may store the provided information in a consumer database 112 into one of a plurality of consumer profiles, discussed in more detail below.

The processing server 110 may also include a coupon database 114, which may store a plurality of coupons as discussed below. In some embodiments, the consumer of the consumer device 102 may “clip” (e.g., select, identify, assign, etc.) coupons stored in the coupon database 114. In other embodiments, the processing server 110 may distribute, assign, etc. coupons stored in the coupon database 114 to the consumer of the consumer device 102. Methods for the distribution of coupons to a consumer will be apparent to persons having skill in the relevant art and may be based on consumer preferences, consumer transaction or offer redemption history, geographic location of the consumer or the merchant, a particular financial transaction, etc.

As part of the checkout process for the financial transaction between the consumer device 102 and the merchant server 104, the consumer device 102 may provide authentication information to the processing server 110 to log in to the discount service. The processing server 110 may identify a consumer profile for the consumer in the consumer database 112 based on the authentication information and may then identify coupons in the coupon database 114 eligible for use in the financial transaction, discussed in more detail below. The processing server 110 may display the identified coupons to the consumer via the consumer device 102, who may then select at least one of the coupons to be applied to the financial transaction. The processing server 110 may identify the selected coupon or coupons and transmit relevant coupon details to the merchant server 104.

The merchant server 104, upon receiving the coupon details, may modify the transaction details for the transaction as stored in the transaction database 108 based on the coupon details, such as by reducing the transaction amount (e.g., subtracting $5 for a $5 off coupon). The merchant server 104 may transmit, on the website as part of the checkout process, the modified transaction details to the consumer device 102 for display to the consumer. The consumer device 102 may provide a confirmation of the transaction details, which may prompt the merchant server 104 to submit an authorization request for the financial transaction to a financial transaction processing agency (e.g., MasterCard®, VISA®, etc.). The financial transaction may be processed by methods apparent to persons having skill in the relevant art.

The merchant server 104 may receive an authorization response, which may indicate if the transaction is approved or denied. The merchant server 104 may then finalize the transaction based on the received authorization response (e.g., informing the consumer of the denied transaction or furnishing the transacted goods and/or services to the consumer). In some embodiments, finalizing the transaction may include notifying the processing server 110 of the use of the selected coupon or coupons.

### Processing Server

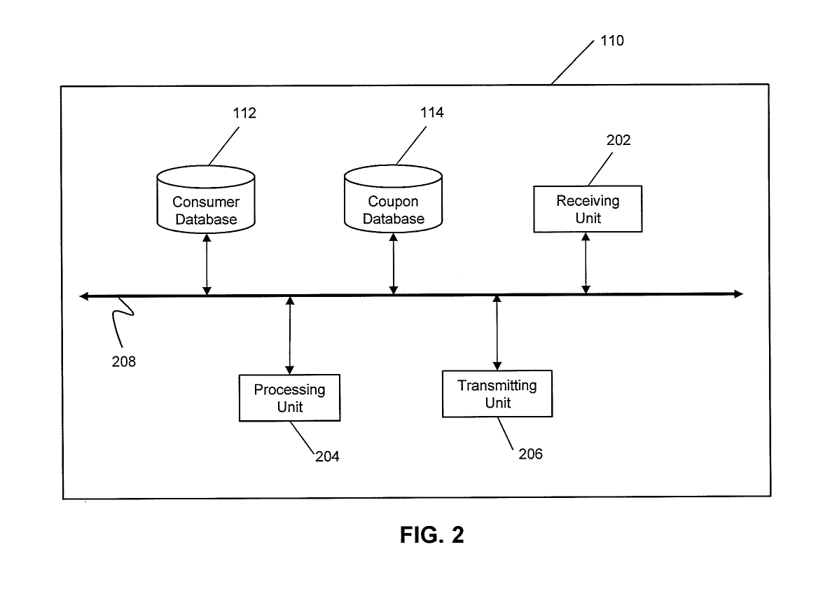

FIG. 2 is an illustration of an embodiment of the processing server 110 of the system 100 for distributing coupons to a consumer for use in a financial transaction. The processing server 110 may include the consumer database 112, the coupon database 114, a receiving unit 202, a processing unit 204, and a transmitting unit 206. Each of the components may be configured to communicate via a bus 208. Suitable types and configurations of the bus 208 will be apparent to persons having skill in the relevant art.

Data stored in the consumer database 112 and the coupon database 114, or the transaction database 108 of the merchant server 104, (the “databases”) may be stored on any type of suitable computer readable media, such as optical storage (e.g., a compact disc, digital versatile disc, Blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 116).

The receiving unit 202 may be configured to receive enrollment information for a consumer enrolling in a discount service. The processing unit 204 may be configured to identify the received information and build a consumer profile for the corresponding consumer, to be stored in the consumer database 112.

The consumer database 112 may be configured to store a plurality of consumer profiles. Each consumer profile may be associated with a consumer using a consumer identifier. The consumer identifier may be any unique value suitable for identifying a unique consumer, such as a username, email address, phone number, financial account number, etc. Each consumer profile may include additional information suitable for the authentication of the consumer, such as a password, security questions, etc., or additional information suitable for the distribution of coupons to the consumer. Information suitable for the distribution of coupons to the consumer may include coupon type preferences (e.g., $ off, % off, buy one get one free, no expiration date, etc.), merchant preferences, industry preferences, notification preferences (e.g., email, phone, mail, short message service (SMS) message, etc.), past transaction history, social network information, and offer redemption history. Additional suitable information will be apparent to persons having skill in the relevant art.

The receiving unit 202 may also be configured to receive information from a consumer identifying coupons that have been selected (e.g., “clipped”) by the consumer. In one embodiment, the consumer may select coupons using a website hosted by or on behalf of the processing server 110. In another embodiment, the consumer may select coupons using an application program on a mobile communication device, such as a smart phone. In some embodiments, the receiving unit 202 may receive information from a merchant or other offer originator indicating that the consumer has been awarded a specific coupon. In other embodiments, the processing unit 204 may identify coupons stored in the coupon database 114, discussed in more detail below, to be associated with the consumer, such as based on consumer transaction history, consumer preferences, etc.

Once coupons have been identified, the processing unit 204 may associate the coupons with the corresponding consumer in the coupon database 114. In some embodiments, associating the coupons may include creating a specific coupon entry for each coupon in the coupon database 114. In other embodiments, associating the coupons may include associating the corresponding coupon in the coupon database 114 with the consumer identifier corresponding to the consumer. In yet another embodiment, associating the coupons may include associating the corresponding consumer profile in the consumer database 112 with the identified coupon in the coupon database 114.

The receiving unit 202 may also be configured to receive, from the consumer device 102 or from the merchant server 104 (e.g., the web hosting server 106) authentication information. The processing unit 204 may be configured to identify a consumer profile in the consumer database 112 based on the authentication information. The processing unit 204 may be further configured to identify coupons associated with the consumer profile in the coupon database 114. The transmitting unit 206 may be configured to transmit the identified coupons to the consumer device 102 or the merchant server 104 for display to the consumer.

In one embodiment, the receiving unit 202 may be further configured to receive transaction information from the merchant server (e.g., stored in the transaction database 108), which may be included in the authentication information or received concurrently with the authentication information. The processing unit 204 may use the received transaction information when identifying coupons associated with the consumer profile in the coupon database 114. In an exemplary embodiment, the processing unit 204 may only identify those coupons eligible for the present financial transaction based on the received transaction information. For example, the processing unit 204 may identify only those coupons in the coupon database 114 associated with the particular consumer and eligible at the particular merchant, for the particular products or services transacted, for the transaction amount, based on the time and/or date of the transaction, etc.

Following transmission of the identified coupons to the consumer device 102 or the merchant server 104, the receiving unit 202 may receive an indication of at least one selected coupon. The processing unit 204 may identify the at least one selected coupon in the coupon database 114 and may transmit relevant coupon details, discussed in more detail below, to the merchant server 104 such that the at least one selected coupon may be applied to the financial transaction.

In some embodiments, the receiving unit 202 may also be configured to receive a notification of the redemption of a coupon, such as from the merchant server 104, the consumer device 102, or a financial transaction processing agency. The processing unit 204 may be configured to update the coupon database 114 and/or the consumer database 112 to reflect the redemption of the coupon, such as by updating transaction or coupon redemption information associated with the consumer, removing the corresponding coupon from being associated with the consumer, decrementing the remaining quantity of a coupon, etc. In one embodiment, the transmitting unit 206 may be configured to transmit or forward notification to the consumer device 102 of the redemption of the coupon.

### Merchant Server

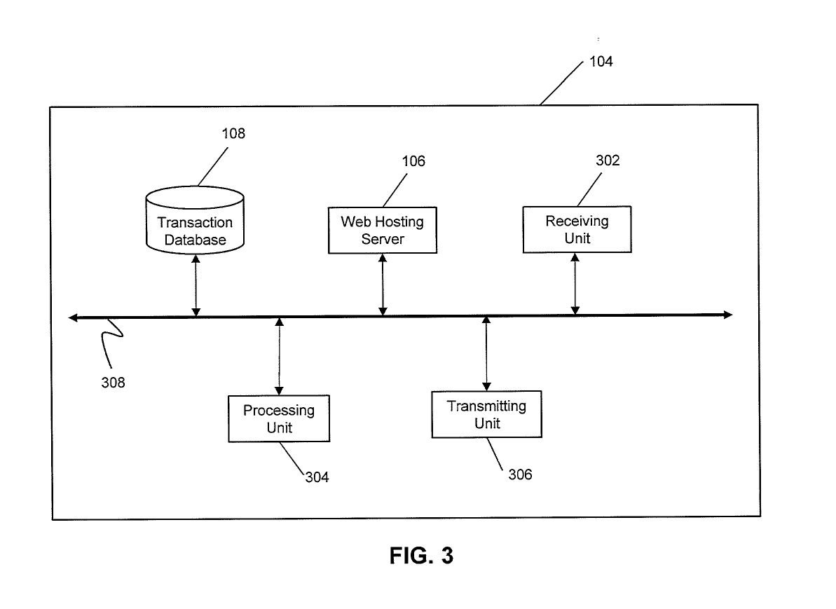

FIG. 3 is an illustration of an embodiment of the merchant server 104 of the system 100 for receiving and applying coupons for use in a financial transaction. The merchant server 104 may include the transaction database 108, a receiving unit 302, a processing unit 304, and a transmitting unit 306. Each of the components may be configured to communicate via a bus 308. Suitable types and configurations of the bus 308 will be apparent to persons having skill in the relevant art. In some embodiments, the merchant server 104 may also include the web hosting server 106. It will be apparent to persons having skill in the art that the web hosting server 106 may be a separate server and may, in some instances, be operated by a separate entity on behalf of the merchant.

The web hosting server 106 may host a webpage displaying products or services available for purchase. A consumer (e.g., via the consumer device 102) may visit the webpage and select products or services. Once the consumer is satisfied with their selections, they may proceed to a “checkout” screen to initiate a financial transaction for the selected products. Methods and systems for e-commerce webpages suitable for performing the functions as disclosed herein will be apparent to persons having skill in the relevant art.

The receiving unit 302 of the merchant server 104 may be configured to receive (e.g., from the web hosting server 106) transaction or product information for a financial transaction with the consumer. The transaction or product information may include, for example, product details, such as product name, product description, product price, product quantity, a product identifier (e.g., universal product code, stock-keeping unit, manufacturer part number, European article number, international standard book number, etc.), and a transaction amount. The processing unit 304 may be configured to store the received transaction information in the transaction database 108.

The receiving unit 302 may also be configured to receive (e.g., via the web hosting server 106) an indication that the consumer is initiating the financial transaction (e.g., checking out). As part of the checkout process, the consumer may indicate that they wish to apply a coupon to the financial transaction. In one embodiment, the receiving unit 302 may receive the indication and the web hosting server 106 may prompt the consumer to enter authentication information, which may be forwarded to the processing server 110. In another embodiment, the receiving unit 302 may receive the indication and the web hosting server 106 may direct the consumer to a web page hosted by or on behalf of the processing server 110. In such an embodiment, modification of the merchant web page to include the discount service may be minimized.

The transmitting unit 306 may be configured to transmit transaction information stored in the transaction database 108 for the financial transaction to the processing server 110, which may use the transaction information to identify eligible coupons. The receiving unit 302 may then receive coupon details for a plurality of eligible coupons from the processing server 110. The coupon details may include relevant information suitable for display to the consumer and use in processing the transaction as will be apparent to persons having skill in the relevant art, such as a coupon identifier, a merchant identifier, a product identifier, a name, an image, a description, an expiration data, a transaction modifier, etc. The web hosting server 106 may display the coupon details for the eligible coupons to the consumer for selection.

The receiving unit 302 may be further configured to receive an indication of at least one selected coupon to be applied to the financial transaction. The processing unit 304 may identify, in the received coupon details, the coupon details corresponding to the at least one selected coupon. The processing unit 304 may be configured to modify the transaction information in the transaction database 108 based on the identified coupon details. For example, the processing unit 304 may reduce the transaction amount for the financial transaction based on the transaction modifier (e.g., discount amount, reward, etc.) of the at least one selected coupon. Methods for modifying a transaction based on coupon details will be apparent to persons having skill in the relevant art. The web hosting server 106 may display the updated transaction information to the consumer and then may receive confirmation from the consumer to process the financial transaction.

The transmitting unit 306 may be configured to transmit an authorization request for the financial transaction to a financial transaction processing agency. The receiving unit 302 may be configured to receive an authorization response, which may indicate if the financial transaction is approved or denied. The web hosting server 106 may display the result of the authorization response to the consumer, and the merchant may finalize the transaction. In some embodiments, the transmitting unit 306 may transmit, to the processing server 110, a notification of redemption of the at least one selected coupon. In a further embodiment, the notification of redemption may include at least a coupon identifier associated with each selected coupon, and a consumer identifier associated with the consumer.

### Coupon Database

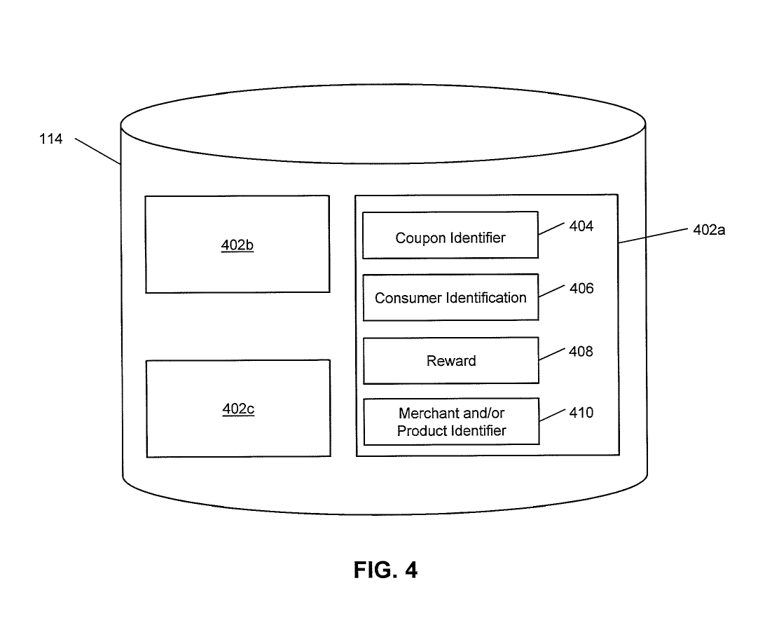

FIG. 4 illustrates an embodiment of the coupon database 114 of the processing server 110 of the system 100. The coupon database 114 may include a plurality of coupons 402, illustrated in FIG. 4 as coupons 402a, 402b, and 402c. Each coupon 402 may include at least a coupon identifier 404, a consumer identification 406, a reward 408, and a merchant and/or product identifier 410. In some embodiments, each coupon 402 may include additional information as will be apparent to persons having skill in the art, which may be dependent on the specific application, such as a name, image, description, terms and conditions, start date, expiration date, quantity, method of payment, minimum transaction amount, maximum transaction amount, etc.

The coupon identifier 404 may be a unique value associated with the coupon 402, such as for the identification of the specific, unique coupon 402. The coupon identifier 404 may be any type of unique value suitable for performing the functions as disclosed herein, such as a universal product code (UPC), stock-keeping unit (SKU), manufacturer part number (MPN), serial number, European article number (EAN), international standard book number (ISBN), or another value type identified by the processing server 110. In one embodiment the coupon identifier 404 may be a coupon code recognized by the merchant server 104. The consumer identification 406 may be a value corresponding to a consumer identifier stored in a consumer profile of the consumer database 112, for the identification of consumer associated with the coupon 402. In one embodiment, the consumer identification 406 may include a plurality of consumer identifiers, such as instances where the coupon database 114 may include a single entry per coupon and each coupon being associated with multiple consumers.

The reward 408 may be any type of discount, transaction modifier, etc. for which the coupon 402 is used. The reward 408 may be in any format suitable for use in performing the functions disclosed herein as will be apparent to persons having skill in the relevant art. In some embodiments, the reward 408 may include multiple representations, such as one formatted for display to the consumer and another formatted for use by the merchant server 104 in modifying the financial transaction. The reward 408 may be any type of reward, discount, offer, coupon, etc. as will be apparent to persons having skill in the relevant art, such as a discount amount (e.g., $5 off), a discount percentage (e.g., 10% off), a free gift, a conditional gift (e.g., buy one get one free), a conditional discount (e.g., 10% off on any purchase of $50 or more, 25% of your fifth visit, etc.), etc.

The merchant and/or product identifier 410 may be a merchant identifier, which may correspond to a particular merchant (e.g., of the merchant server 104) for which the coupon 402 may be eligible, or may be a product identifier, which may correspond to a particular product (e.g., or manufacturer) for which the coupon 402 may be eligible. The merchant and/or product identifier 410 may be used by the processing server 110 to identify eligible coupons to transmit to the consumer device 102 and/or the merchant server 104, such as by comparing a merchant identifier 410 with the merchant server 104, or by comparing a product identifier 410 with each product included in the transaction information. Values used as the merchant and/or product identifier 410 will be apparent to persons having skill in the relevant art, such as a merchant identification number (MID), UPC, SKU, etc.

In some embodiments, each coupon 402 may also include a market identifier. The market identifier may be a value indicating a market (e.g., a category, industry, demographic, etc.) to which the coupon 402 may be distributed. In a further embodiment, each consumer profile in the consumer database 112 may include a plurality of market identifiers such that a consumer may only transfer a coupon 402 from themselves to another consumer if the market identifier of the coupon 402 is included in the other consumer's plurality of market identifiers. Such an embodiment may be useful for preventing the transfer of coupons 402 from a specifically targeted consumer to another that may not be ideal for a particular merchant or originator.

### Graphical User Interface

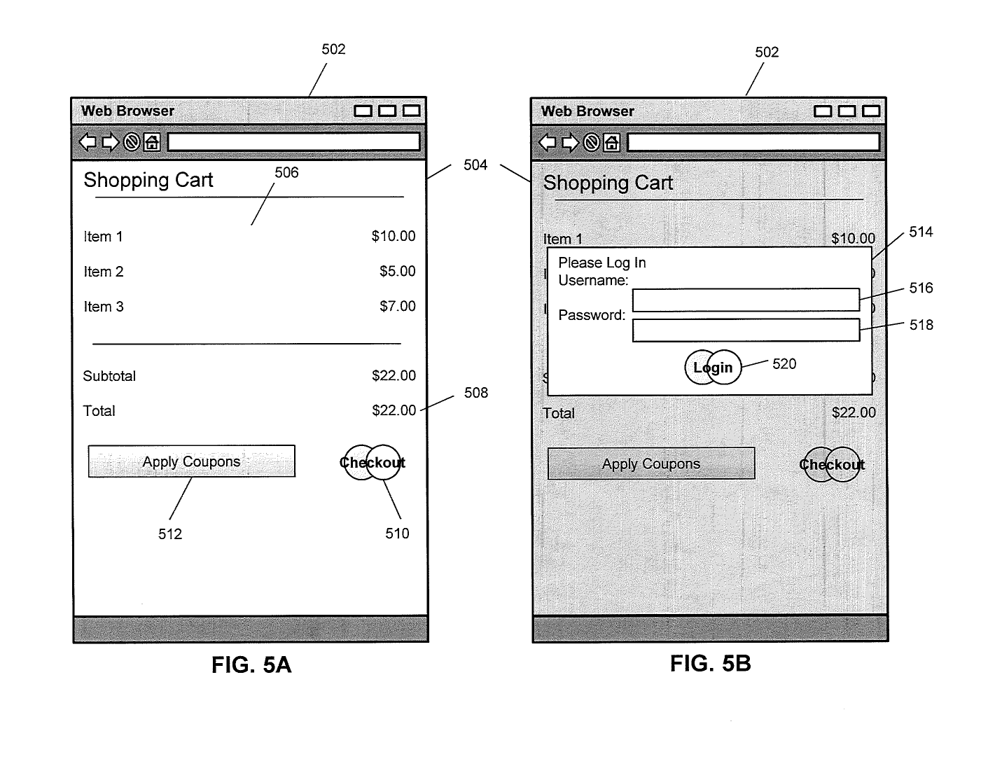

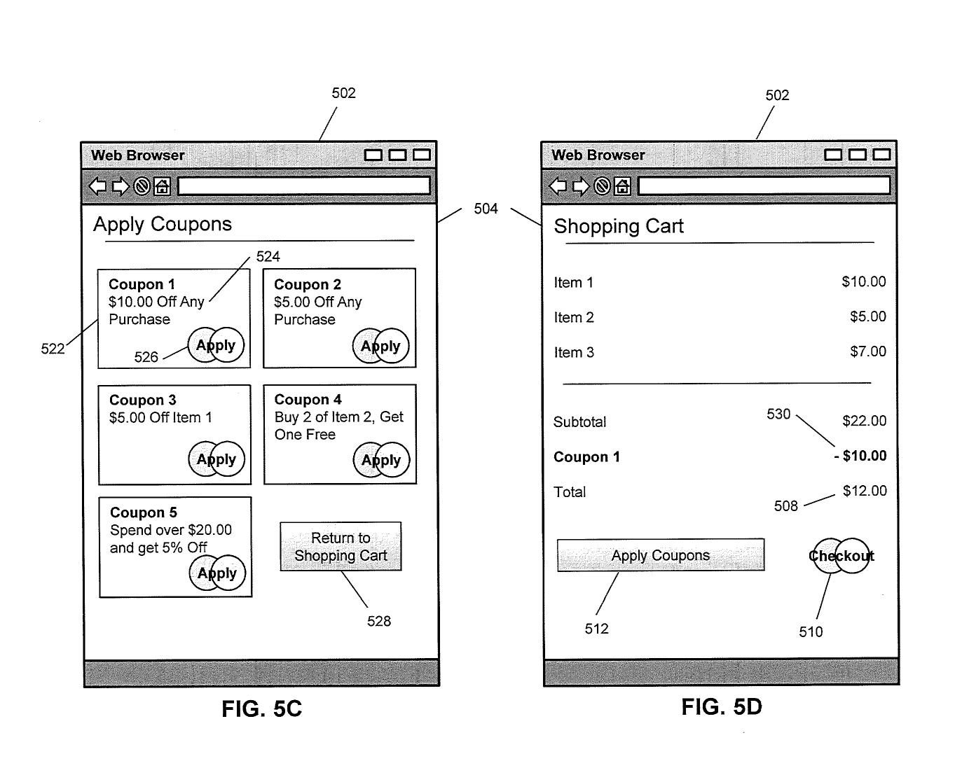

FIGS. 5A-5D illustrate an exemplary graphical user interface of a merchant webpage, which may be hosted by the web hosting server 106 on or behalf of the merchant server 104 and viewed via the consumer device 102.

A consumer using the consumer device 102 may navigate to the merchant webpage 504 using a web browser 502 or any other application program suitable for viewing web pages. The consumer may select products or services for purchase using the merchant webpage, and then visit a shopping cart or similar page, which may display all of the selected products or services to the consumer, such as illustrated in FIG. 5A. The shopping cart may display a list of product information 506, which may include product names, product quantity, and product prices. The shopping cart may also display a transaction amount 508, which may be the amount which the consumer must pay for the financial transaction.

The shopping cart may also include a checkout button 510, which may initiate processing of the financial transaction, and a coupon button 512. When the consumer interacts with (e.g., clicks, etc.) the coupon button 512, the consumer may be presented with an authentication box 514, as illustrated in FIG. 5B. The authentication box 514 may be displayed as an overlay to the webpage 504, such as illustrated. In some embodiments, the authentication box 514 may be displayed in a separate window, or may be displayed as a separate webpage on the web browser 502. Suitable methods for implementing and displaying the authentication box 514 will be apparent to persons having skill in the relevant art.

The authentication box 514 may prompt the consumer to enter authentication information to log in to the discount service. For example, the authentication box 514 may include fields for the consumer to enter a username 516 and a password 518. The consumer may enter their corresponding information in the username 516 and password 518 fields, and then may interact with a login button 520. When the consumer interacts with the login button 520, the provided authentication information may be received by the receiving unit 202 of the processing server 110. In one embodiment, the authentication information may be transmitted by the web hosting server 106 (e.g., via the transmitting unit 306) of the merchant server 104. In another embodiment, the authentication box 514 may be hosted by the processing server 110 and the authentication information collected locally.

The processing server 110 may, as discussed in more detail herein, identify a plurality of eligible coupons associated with the consumer and transmit the coupon details for the identified coupons to the web hosting server 106. The web hosting server 106 may display the identified coupons on the merchant webpage 504 to the consumer as illustrated in FIG. 50. The merchant webpage 504 may include a plurality of displayed coupons 522, each of which may include a variety of coupon details as will be apparent to persons having skill in the relevant art. Each displayed coupon 522 may include a reward 524, which may correspond to the reward 408 of the corresponding coupon 402 entry in the coupon database 114 of the processing server 110. Each displayed coupon 522 may also include an apply button 526. When the consumer interacts with the apply button 522, the merchant server 104 may apply the selected coupon to the financial transaction as disclosed herein. The merchant webpage 504 may also display a return button 528, which may allow the consumer to return to the shopping cart illustrated in FIG. 5A without applying any of the coupons.

Once a coupon has been applied to the financial transaction, the web hosting server 106 may display an updated shopping cart page to the consumer, such as illustrated in FIG. 5D. The updated shopping cart may display, in addition to the original information, a discount amount 530. The discount amount 530 may reflect the discount taken from the original transaction amount based on the reward 524 of the selected coupon. The shopping cart may also display an updated transaction amount 508 to reflect the price of the transaction following application of the coupon. The updated shopping cart may still display the coupon button 512, such that the consumer may be able to apply additional coupons to the transaction. In some instances, the coupon button 512 may not be displayed, such as if the merchant accepts only one coupon per transaction. When the consumer is satisfied, they may interact with the checkout button 510 to initiate processing of the financial transaction.

### Method for Coupon Distribution and Application

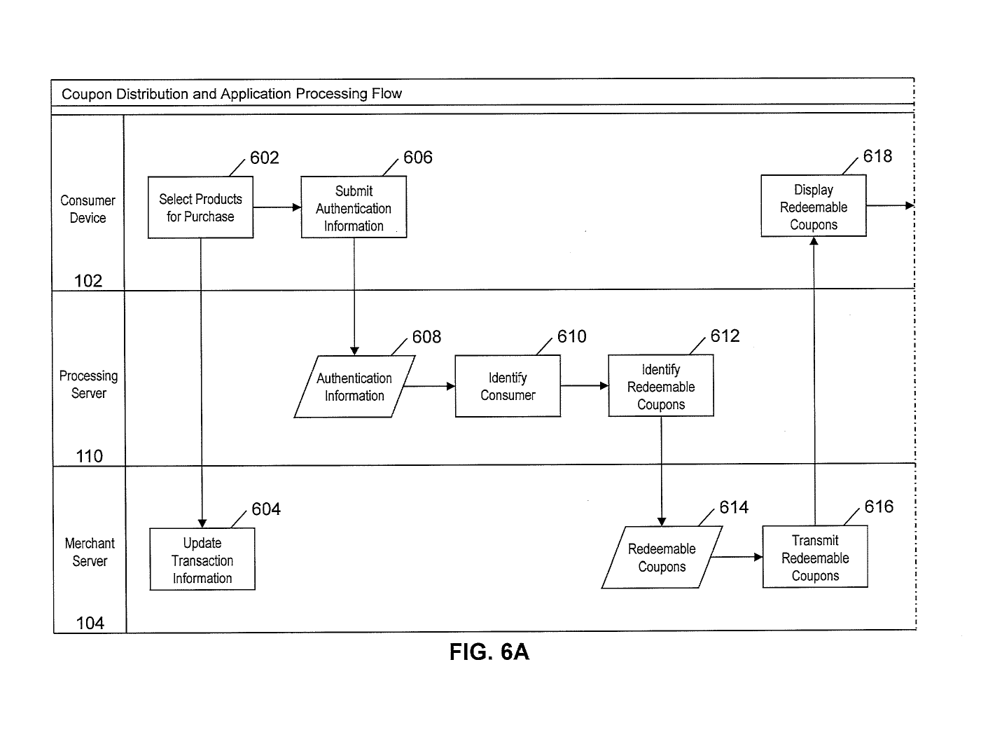

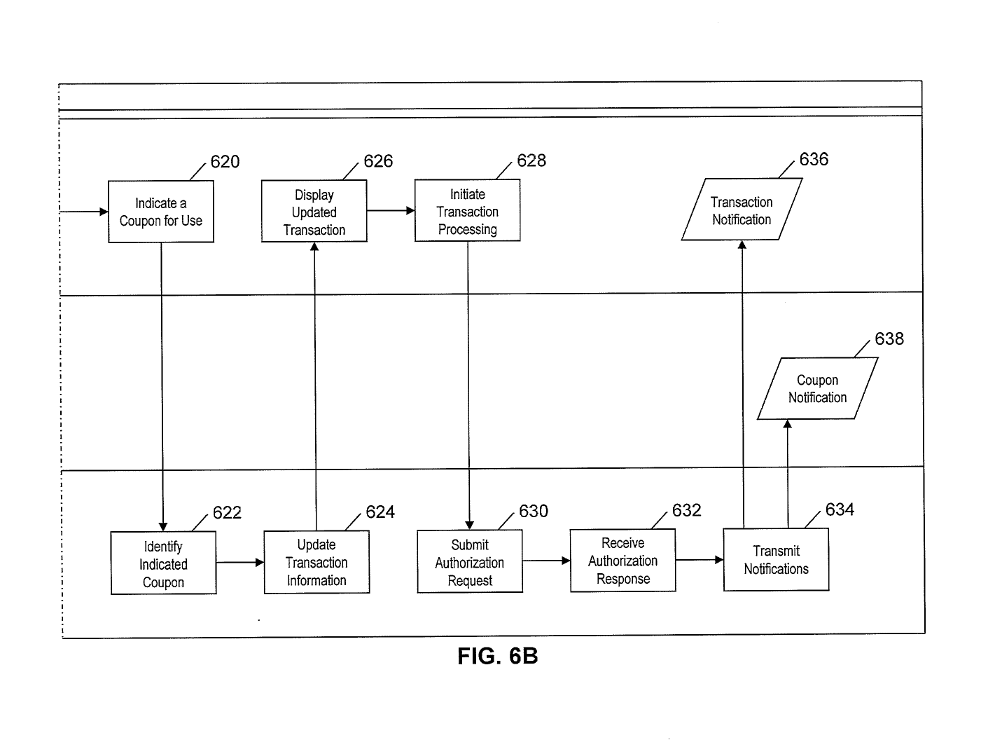

FIGS. 6A and 6B illustrate a processing flow for a method for the distribution and application of coupons for use in a financial transaction using the system 100 of FIG. 1.

In step 602, the consumer may select products for purchase available at the merchant website using the consumer device 102. In step 604, the merchant server 104 may identify product details based on the selections made by the consumer and update the transaction information for the financial transaction based on the consumer selections. In one embodiment, the transaction information may be stored in the transaction database 108. In an exemplary embodiment, the transaction information may include at least a transaction amount.

In step 606, the consumer may submit authentication information to identify the consumer as being enrolled in a discount service, which may be received by the processing server 110 in step 608. In one embodiment, the authentication information may include at least one of: a username, a password, an e-mail address, an account number, a personal identification number (PIN), and a phone number. In step 610, the processing server 110 may identify a consumer profile in the consumer database 112 associated with the consumer based on the received authentication information.

In step 612, the processing server 110 may identify coupons eligible for redemption by the consumer in the particular financial transaction. Identifying coupons may include identifying, in the coupon database 114, coupons that include a consumer identification corresponding to the consumer identifier of the identified consumer profile. In some embodiments, step 612 may also include receiving, from the merchant server 104, the transaction information for the financial transaction, and identifying only those coupons in the coupon database 114 associated with the consumer and also eligible based on the transaction information. For example, some coupons identified as being associated with the consumer may not be redeemable because of an invalid expiration date, inadequate transaction amount, etc.

In step 614, the processing server 110 may transmit the identified coupons to the merchant server 104, which may receive the identified coupons. The transmitted coupons may include at least a coupon identifier 402 and a merchant and/or product identifier 410. In one embodiment, the merchant and/or product identifier 410 may be one of: a merchant identification number (MID), a universal product code (UPC), a serial number, a manufacturer part number (MPN), a European article number (EAN), an international standard book number (ISBN), and a stock-keeping unit (SKU). In step 616, the merchant server 104 may transmit the identified coupons to the consumer device 102 (e.g., via the web hosting server 106). In step 618, the consumer device 102 may display the identified, redeemable coupons to a consumer for selection to be applied to the transaction.

In step 620, the consumer may indicate at least one coupon 402 for use in the financial transaction using the consumer device 102. In some embodiments, the consumer may indicate a plurality of coupons. In another embodiment, the consumer may indicate only a single coupon 402 for use in the financial transaction. In step 622, the merchant server 104 may identify the indicated coupon 402, such as based on the coupon identifier 404. Then, in step 625, the merchant server 104 may (e.g., via the processing unit 302) update the transaction information for the financial transaction. In an exemplary embodiment, updating the transaction information may include reducing the transaction amount based on the reward 408 of each coupon 402 of the indicated at least one coupon 402.

In step 626, the consumer device 102 may display the updated transaction information, which may reflect the application of the previously indicated at least one coupon 402 to the transaction. Then, in step 628, the consumer may use the consumer device 102 to initiate processing of the financial transaction. The merchant server 104 may initiate processing by, in step 630, submitting an authorization request for the financial transaction to a financial transaction processing agency, where the authorization request is for the updated transaction amount.

In step 632, the merchant server 104 may receive an authorization response as a response to the authorization request. The authorization response may indicate whether the transaction (e.g., and in some instances, the redemption of the indicated coupon 402) is approved or denied. The merchant may finalize the transaction based on the response and may, in step 634, transmit notifications to the consumer device 102 and to the processing server 110. In step 636, the consumer device 102 may receive a transaction notification, which may indicate to the consumer whether or not the transaction has been approve or denied and any additional suitable details as will be apparent to persons having skill in the relevant art, such as a receipt, shipping information, an order number, etc. In step 638, the processing server 110 may receive a coupon notification, which may indicate redemption of the indicated coupon 402 and may include at least the corresponding coupon identifier 404.

### Computer System Architecture

FIG. 7 illustrates a computer system 700 in which embodiments of the present disclosure, or portions thereof, may be implemented as computer-readable code. For example, the consumer device 102, the merchant server 104, and the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6A, 6B, 8, and 9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network (e.g., the network 116), multi-core message-passing scheme, etc. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 6A, 6B, 8, and 9, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

### Exemplary Method for Distributing Coupons for Use in a Financial Transaction

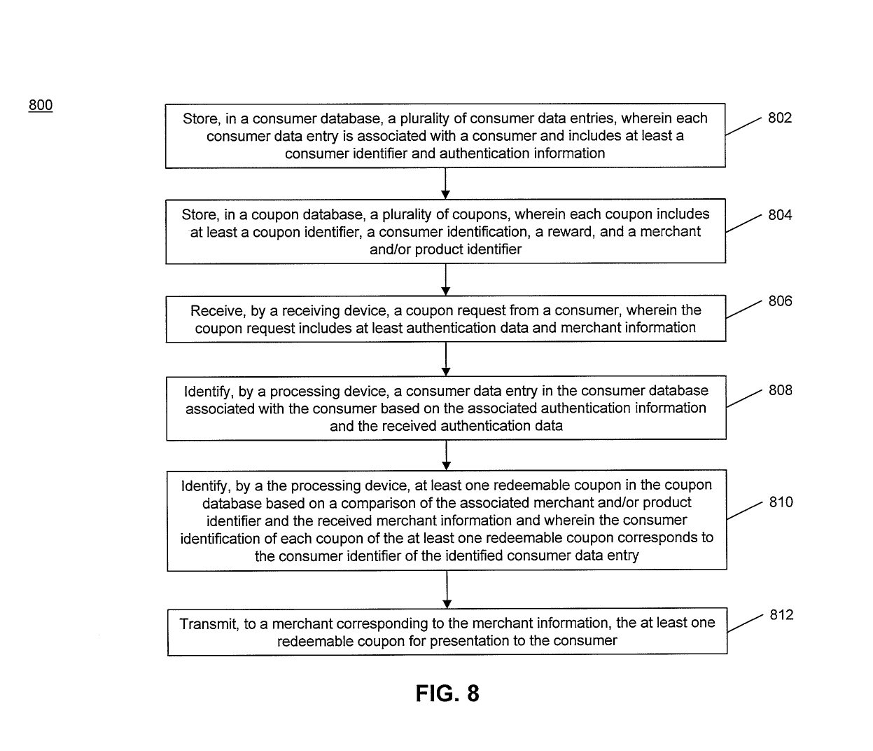

FIG. 8 illustrates a method 800 for distributing coupons for use in a financial transaction.

In step 802, a plurality of consumer data entries may be stored in a consumer database (e.g., the consumer database 112), wherein each consumer data entry is associated with a consumer (e.g., of the consumer device 102) and includes at least a consumer identifier and authentication information. In one embodiment, each consumer data entry may further include a plurality of market identifiers. In step 804, a plurality of coupons (e.g., coupons 402) may be stored in a coupon database (e.g., the coupon database 114), wherein each coupon 402 includes at least a coupon identifier (e.g., the coupon identifier 404), a consumer identification (e.g., the consumer identification 406), a reward (e.g., the reward 408), and a merchant and/or product identifier (e.g., the merchant and/or product identifier 410).

In some embodiments, each coupon 402 may further include an identified market. In a further embodiment, a coupon 402 may only be transferred from an associated consumer to a second consumer whose corresponding consumer data entry includes a market identifier of the plurality of market identifiers corresponding to the identified market associated with the coupon 402. In one embodiment, each coupon 402 may further include at least one of: a condition for redemption, an expiration date, a quantity limit, a limitation on transfer, and a merchant coupon code. In some embodiments, the market and/or product identifier 410 may include at least one of: a merchant identification number (MID), a universal product code (UPC), serial number, manufacturer part number (MPN), international standard book number (ISBN), stock-keeping unit (SKU), and European article number (EAN).

In step 806, a coupon request may be received, by a receiving device (e.g., the receiving unit 202), wherein the coupon request includes at least authentication data and merchant information. In one embodiment, the authentication data may include at least one of: a username, a password, an e-mail address, an account number, a personal identification number (PIN), and a phone number. In step 808, a processing device (e.g., the processing unit 210) may identify a consumer data entry in the consumer database 112 associated with a consumer based on the associated authentication information and the received authentication data.

In step 810, the processing unit 204 may identify at least one redeemable coupon in the coupon database 114 based on a comparison of the associated merchant and/or product identifier 410 and the received merchant information, and wherein the consumer identification 406 of each coupon 402 of the at least one redeemable coupon corresponds to the consumer identifier of the identified consumer data entry. In one embodiment, if the merchant and/or product identifier 410 identifies a consumer product available for purchase, the comparison of the associated merchant and/or product identifier 410 and the received merchant information may include identifying is a consumer product is available for purchase from the merchant (e.g., the merchant server 104). In step 812, the at least one redeemable coupon may be transmitted (e.g., via the transmitting unit 206) to a merchant corresponding to the merchant information for presentation to the consumer.

### Exemplary Method for Receiving and Applying Coupons in a Financial Transaction

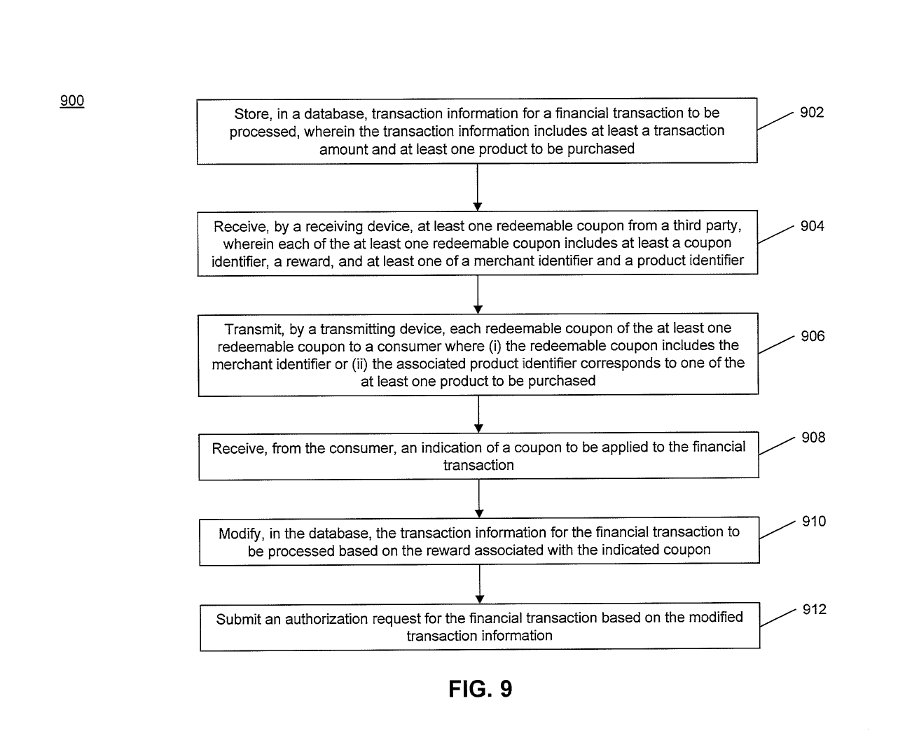

FIG. 9 illustrates a method 900 for receiving and applying coupons for use in a financial transaction.

In step 902, transaction information for a financial transaction to be processed may be stored in a database (e.g., the transaction database 108), wherein the transaction information includes at least a transaction amount and at least one product to be purchased. In step 904, at least one redeemable coupon (e.g., the coupon 402) may be received by a receiving device (e.g., the receiving unit 302) from a third party (e.g., the processing server 110), wherein each of the at least one redeemable coupon 402 includes at least a coupon identifier (e.g., the coupon identifier 404), a reward (e.g., the reward 408) and at least one of a merchant identifier and a product identifier. In one embodiment, each redeemable coupon 402 may further include at least one of: a condition for redemption, an expiration date, a quantity limit, a limitation on transfer, and a merchant coupon code. In one embodiment the product identifier may include at least one of: a UPC, serial number, MPN, ISBN, SKU, and EAN.

In step 906, a transmitting device (e.g., the transmitting unit 306) may transmit each redeemable coupon 402 of the at least one redeemable coupon 402 to a consumer (e.g., the consumer device 102) where (i) the redeemable coupon includes the merchant identifier or (ii) the associated product identifier corresponds to one of the at least one product to be purchased. In one embodiment, transmitting each redeemable coupon 402 may further include transmitting web page data to the consumer device 102, wherein the web page data is configured to display a web page including each redeemable coupon 402.

In step 908, an indication of a coupon 402 to be applied to the financial transaction may be received from the consumer device 102. In step 910, the transaction information for the financial transaction may be modified, in the transaction database 108, based on the reward associated with the indicated coupon. In step 912, an authorization request for the financial transaction may be submitted, the authorization request based on the modified transaction information. In one embodiment, the method 900 may further include transmitting, to the third party, notification of redemption of the indicated coupon 402 by the consumer, wherein the notification of redemption includes at least the coupon identifier 404 associated with the coupon 402.

Techniques consistent with the present disclosure provide, among other features, systems and methods for distributing, receiving, and applying coupons for use in financial transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing coupons for use in a financial transaction, comprising:
storing, in a consumer database, a plurality of consumer data entries, wherein each consumer data entry is associated with a consumer and includes at least a consumer identifier and authentication information;
storing, in a coupon database, a plurality of coupons, wherein each coupon includes at least a coupon identifier, a consumer identification, a reward, and a merchant and/or product identifier;
receiving, by a receiving device, a coupon request, wherein the coupon request includes at least authentication data and merchant information;
identifying, by a processing device, a consumer data entry in the consumer database associated with a consumer based on the associated authentication information and the received authentication data;
identifying, by the processing device, at least one redeemable coupon in the coupon database based on a comparison of the associated merchant and/or product identifier and the received merchant information and wherein the consumer identification of each coupon of the at least one redeemable coupon corresponds to the consumer identifier of the identified consumer data entry; and
transmitting, to a merchant corresponding to the merchant information, the at least one redeemable coupon for presentation to the consumer.

2. The method of claim 1, wherein each coupon of the plurality of coupons further includes at least one of: a condition for redemption, an expiration date, a quantity limit, a limitation on transfer, and a merchant coupon code.

3. The method of claim 1, wherein
each consumer data entry of the plurality of consumer data entries further includes a plurality of market identifiers,
each coupon of the plurality of coupons further includes an identified market, and
a coupon can only be transferred from the associated consumer to a second consumer whose corresponding consumer data entry includes a market identifier of the plurality of market identifiers corresponding to the identified market associated with the coupon.

4. The method of claim 1, wherein the received market and/or product identifier includes at least one of a merchant identification number (MID), a universal product code (UPC), serial number, manufacturer part number (MPN), international standard book number (ISBN), stock-keeping unit (SKU), and European article number (EAN).

5. The method of claim 1, wherein the merchant and/or product identifier identifies a consumer product available for purchase, and the comparison of the associated merchant and/or product identifier and the received merchant information includes identifying if consumer product is available for purchase from the merchant.

6. The method of claim 1, wherein the authentication data includes at least one of: a username, a password, an e-mail address, an account number, a personal identification number (PIN), and a phone number.

7. A method for receiving and applying coupons for use in a financial transaction, comprising:
storing, in a database, transaction information for a financial transaction to be processed, wherein the transaction information includes at least a transaction amount 508 and at least one product to be purchased;
receiving, by a receiving device, at least one redeemable coupon from a third party, wherein each of the at least one redeemable coupon includes at least a coupon identifier, a reward, and at least one of a merchant identifier and a product identifier;
transmitting, by a transmitting device, each redeemable coupon of the at least one redeemable coupon to a consumer where (i) the redeemable coupon includes the merchant identifier or (ii) the associated product identifier corresponds to one of the at least one product to be purchased;
receiving, from the consumer, an indication of a coupon to be applied to the financial transaction;
modifying, in the database, the transaction information for the financial transaction to be processed based on the reward associated with the indicated coupon; and
submitting an authorization request for the financial transaction based on the modified transaction information.

8. The method of claim 7, wherein each redeemable coupon of the at least one redeemable coupon further includes at least one of: a condition for redemption, an expiration date, a quantity limit, a limitation on transfer, and a merchant coupon code.

9. The method of claim 7, wherein the product identifier includes at least one of a universal product code (UPC), serial number, manufacturer part number (MPN), international standard book number (ISBN), stock-keeping unit (SKU), and European article number (EAN).

10. The method of claim 7, wherein transmitting each redeemable coupon of the at least one redeemable coupon to the consumer includes transmitting web page data to the consumer, the web page data being configured to display a web page including each redeemable coupon.

11. The method of claim 7, further comprising:
transmitting, to the third party, notification of redemption of the coupon by the consumer, wherein the notification of redemption includes at least the coupon identifier associated with the coupon.

12. A system for distributing coupons for use in a financial transaction, comprising:
a consumer database configured to store a plurality of consumer data entries, wherein each consumer data entry is associated with a consumer and includes at least a consumer identifier and authentication information;
a coupon database configured to store a plurality of coupons, wherein each coupon includes at least a coupon identifier, a consumer identification, a reward, and a merchant and/or product identifier;
a receiving device configured to receive a coupon request, wherein the coupon request includes at least authentication data and merchant information;
a processing device configured to
identify a consumer data entry in the consumer database associated with a consumer based on the associated authentication information and the received authentication data, and
identify at least one redeemable coupon in the coupon database based on a comparison of the associated merchant and/or product identifier and the received merchant information and wherein the consumer identification of each coupon of the at least one redeemable coupon corresponds to the consumer identifier of the identified consumer data entry; and
a transmitting device configured to transmit, to a merchant corresponding to the merchant information, the at least one redeemable coupon for presentation to the consumer.

13. The system of claim 12, wherein each coupon of the plurality of coupons further includes at least one of: a condition for redemption, an expiration date, a quantity limit, a limitation on transfer, and a merchant coupon code.

14. The system of claim 12, wherein
each consumer data entry of the plurality of consumer data entries further includes a plurality of market identifiers,
each coupon of the plurality of coupons further includes an identified market, and
a coupon can only be transferred from the associated consumer to a second consumer whose corresponding consumer data entry includes a market identifier of the plurality of market identifiers corresponding to the identified market associated with the coupon.

15. The system of claim 12, wherein the received market and/or product identifier includes at least one of a merchant identification number (MID), a universal product code (UPC), serial number, manufacturer part number (MPN), international standard book number (ISBN), stock-keeping unit (SKU), and European article number (EAN).

16. The system of claim 12, wherein the merchant and/or product identifier identifies a consumer product available for purchase, and the comparison of the associated merchant and/or product identifier and the received merchant information includes identifying if consumer product is available for purchase from the merchant.

17. The system of claim 12, wherein the authentication data includes at least one of: a username, a password, an e-mail address, an account number, a personal identification number (PIN), and a phone number.

18. A system for receiving coupons and applying coupons for use in a financial transaction, comprising:
a database configured to store transaction information for a financial transaction to be processed, wherein the transaction information includes at least a transaction amount and at least one product to be purchased;
a receiving device configured to receive, from a third party, at least one redeemable coupon, wherein each of the at least one redeemable coupon includes at least a coupon identifier, a reward, and at least one of a merchant identifier and a product identifier;
a transmitting device configured to transmit, to a consumer, each redeemable coupon of the at least one redeemable coupon where (i) the redeemable coupon includes the merchant identifier or (ii) the associated product identifier corresponds to one of the at least one product to be purchased; and
a processing device configured to
cause the receiving device to receive, from the consumer, an indication of a coupon to be applied to the financial transaction,
modify, in the database, the transaction information for the financial transaction to be processed based on the reward associated with the indicated coupon, and
submit an authorization request for the financial transaction based on the modified transaction information.

19. The system of claim 18, wherein each redeemable coupon of the at least one redeemable coupon further includes at least one of: a condition for redemption, an expiration date, a quantity limit, a limitation on transfer, and a merchant coupon code.

20. The system of claim 18, wherein the product identifier includes at least one of a universal product code (UPC), serial number, manufacturer part number (MPN), international standard book number (ISBN), stock-keeping unit (SKU), and European article number (EAN).

21. The system of claim 18, wherein transmitting each redeemable coupon of the at least one redeemable coupon to the consumer includes transmitting web page data to the consumer, the web page data being configured to display a web page including each redeemable coupon.

22. The system of claim 18, wherein the transmitting device is further configured to:
transmit, to the third party, notification of redemption of the coupon by the consumer, wherein the notification of redemption includes at least the coupon identifier associated with the coupon.
